(19) United States
(12) Patent Application Publication
(10) Pub. No.: US 2003/0092344 A1
(43) Pub. Date: May 15, 2003

(54) Outdoor fabric with improved barrier performance

(75) Inventors: Julia A. Thompson, Los Alamos, NM (US); Nick Mark Carter, Mooresville, NC (US); Richard Ferencz, Isle of Palms, SC (US)

Correspondence Address: WOOD, PHILLIPS, KATZ, CLARK & MORTIMER, 500 W. MADISON STREET, SUITE 3800, CHICAGO, IL, 60661, US

(73) Assignee: Polymer Group, Inc.

(21) Appl. No.: 10/263,482

(22) Filed: Oct. 3, 2002

Related U.S. Application Data
(60) Provisional application No. 60/327,465, filed on Oct. 5, 2001.

(51) Int. Cl. D04H 1/00; D04H 3/00; D04H 5/00; B32B 27/12

(52) U.S. Cl. 442/401; 442/340; 442/361; 442/400; 442/394; 442/409

(57) ABSTRACT

The present invention is directed to a protective outdoor fabric comprising one or more layers of fine denier spunbond filaments and at least one layer of barrier material, wherein said protective outdoor fabric has a significant barrier performance as measured by the hydrostatic head to barrier layer basis weight ratio being of about at least 4.9 cm/gsm. In the preferred practice of the present invention, first and second outer fabric layers are formed, each comprising continuous filament spunbond layers of thermoplastic fibers, with the size of the continuous filaments between about 0.7 and 1.2 denier, preferably less than or equal to 1 denier. The barrier layer preferentially comprises microfibers of finite length, wherein the average fiber diameter is in the range of about 1 micron to about 10 microns, and preferably between about 1 micron and 5 microns, said layers being consolidated into a composite fabric.

### TECHNICAL FIELD

The present invention relates generally to outdoor, recreational and protective fabrics, and specifically, to protective outdoor fabrics with improved barrier to basis weight performance. The improved protective outdoor fabrics are prepared by continuously extruding essentially endless, thermoplastic polymer, fine denier filaments. Incorporation of at least one conventional melt-blown filament layer deposited upon or between one or more layers of the fine denier filament material has resulted in fabrics, which have exhibited enhanced barrier performance in comparison to conventional outdoor, recreational, and protective constructs.

### BACKGROUND OF THE INVENTION

Nonwoven fabrics are used in a wide variety of applications where the engineered qualities of the fabrics can be advantageously employed. The use of selected thermoplastic polymers in the construction of the fibrous fabric component, selected treatment of the fibrous component (either while in fibrous form or in an integrated structure), and selected use of various mechanisms by which the fibrous component is integrated into a useful fabric, are typical variables by which to adjust and alter the performance of the resultant nonwoven fabric.

In and of themselves, continuous filament fabrics are relatively highly porous, and ordinarily require an additional component in order to achieve the required barrier performance. Typically, barrier performance has been enhanced by the use of a barrier “melt-blown” layer of very fine filaments, which are drawn and fragmented by a high velocity air stream, and deposited into a self-annealing mass. Typically, such a melt-blown layer exhibits very low porosity, enhancing the barrier properties of composite fabrics formed with spunbond and melt-blown layers.

Outdoor fabrics, including such applications as car covers, tarpaulins, tents, and durable sports apparel, are used to protect an object from the deleterious effects of repeated and prolonged environmental exposure. Exposure to humid environments, strong ultraviolet energy, and synthetic or natural detritus, will, for example, quickly compromise both the practical and aesthetic performance of a painted automotive surface.

Early woven materials, such as cotton-ducking, were commonly employed in the role of a protective layer draped on or about an object stored out-of-doors. Unless the cotton-ducking was impregnated or coated with a hydrophilic chemistry, the material would soon become wetted, and due to the natural cellulosic composition, would harbor mold and bacterial growth which was at least as deleterious to the intended object of protection as not having the protective layer at all. Further, direct sunlight would quickly degrade the cellulosic composition of the cotton-ducking, resulting in the progressive loss of physical performance.

More recently, a number of approaches have been taken to alleviate the inherent problems of natural fiber protective outdoor materials. U.S. Pat. No. 6,100,208, is directed to the use of multi-component fibers incorporating ultraviolet stabilizers, in combination with an interposed barrier layer, to obtain a suitably breathable material. U.S. Pat. No. 6,156,421, is directed to use of microporous thermoplastic film which is layered upon a nonwoven substrate.

A common problem identified in the use of not only the early cotton-ducking, but also in the more recent developments in the outdoor protective materials, is the significant weight of the fabrics required to obtain suitable performance. Typically, in order to obtain sufficient strength, durability, and performance, a plurality of layers and/or significant loading of topically applied chemistries have been practiced. This increase in weight is deleterious in outdoor protective fabric applications as the object is require to support the weight for prolonged periods. Further, the weight of these materials can significantly increase the potential of abrasive destruction when ubiquitous particulates are repeatedly played against the surface of the object, such as during the deployment and removal of the protective material and subsequent agitation due to wind.

An unmet need exists for an outdoor protective fabric exhibiting sufficient barrier and durable performance without the necessary addition of weight to the construct. The present invention contemplates that the provision of one or more fine denier spunbond layers significantly improves the formation of the barrier performance in the protective outdoor fabric, without necessarily increasing the overall weight of the construction. The fine denier spunbond layer provides a more uniform interface between the spunbond layer and a subsequent barrier layer applied during the manufacture of the protective outdoor fabric, resulting in improved barrier performance in the fabricated article.

### SUMMARY OF THE INVENTION

The present invention is directed to a protective outdoor fabric comprising one or more layers of fine denier spunbond filaments and at least one layer of barrier material, wherein said protective outdoor fabric has a significant barrier performance as measured by the hydrostatic head to barrier layer basis weight ratio being of about at least 4.9 cm/gsm. In the preferred practice of the present invention, first and second outer fabric layers are formed, each comprising continuous filament spunbond layers of thermoplastic fibers, with the size of the continuous filaments between about 0.7 and 1.2 denier, preferably less than or equal to 1 denier. The barrier layer preferentially comprises microfibers of finite length, wherein the average fiber diameter is in the range of about 1 micron to about 10 microns, and preferably between about 1 micron and 5 microns, said layers being consolidated into a composite fabric.

The thermoplastic polymers of the continuous filament spunbond layer or layers are chosen from the group consisting of polyolefins, polyamides and polyesters, wherein the polyolefins are chosen from the group consisting of polypropylene, polyethylene, and combinations thereof. It is within the purview of the present invention that the continuous filament spunbond layer or layers may comprise either the same or different thermoplastic polymers. Further, the continuous filaments of the spunbond layer or layers may comprise homogeneous, bicomponent, and/or multi-component profiles and the blends thereof.

The barrier layer comprises a material selected from suitable media, such media include: meltblown, cellulosic pulp, microporous film or monolithic film, with microfiber media such as meltblown being preferred. The thermoplastic polymers of the meltblown microfibers are chosen from the group consisting of polyolefins and polyesters, wherein the polyolefins are chosen from the group consisting of polypropylene, polyethylene, and combinations thereof. It is within the purview of the present invention that the microfibers may comprise either the same or different thermoplastic polymers. Further, the microfibers may comprise homogeneous, bicomponent, and/or multi-component profiles and the blends thereof.

In a further aspect of the method of producing a protective outdoor fabric in accordance with the present invention, formation of a composite fabric structure entails the formation of first and second outer, spunbond web layers, and plural barrier melt-blown layers, for example, two, melt-blown barrier layers. Preferably, at least the first outer, spunbond web layer is formed from a plurality of endless filaments having a denier of between 0.7 and 1.2 denier, with each outer layer preferably formed with the same basis weight, and from the same denier filaments. Formation of plural barrier melt-blown layers can be effected such that each of the melt-blown layers is formed to have the same basis weight.

In a fabric formed in accordance with the present invention, the incorporation of fine denier spunbond layers provide substantial improvement in barrier function, allowing for reduction in the amount of the spunbond and/or barrier layer required to meet performance criteria. The substantial improvement in barrier function with the incorporation of the fine denier spunbond layer provides a more uniform support layer for the barrier layer during the manufacturing process and in the resulting end-use articles.

Formation of fabrics from fine denier spunbond materials, particularly when combined with one or more barrier melt-blown layers, has been found to provide enhanced barrier properties. The present invention allows the production of a same weight fabric with improved barrier properties or a lighter weight fabric that is suitable for use as a protective outdoor fabric, particularly for car covers and recreational articles such as tents. Further, the presence of a fine denier spunbond layer as an inner-most layer allows for reduction in the frictional qualities of the protective outdoor fabric, due either inherently to the spunbond or from entrainment of particulates or other foreign matter therein, thus reducing the potential for deleterious effect of prolonged use of the material.

Other features and advantages of the present invention will become readily apparent from the following detailed description, the accompanying drawings, and the appended claims.

### DETAILED DESCRIPTION

While the present invention is susceptible of embodiment in various forms, there will hereinafter be described, presently preferred embodiments, with the understanding that the present disclosure is to be considered as an exemplification of the invention, and is not intended to limit the invention to the specific embodiments disclosed herein.

The present invention is directed to a protective outdoor fabric, which entails formation of a layer of fine denier spunbond filaments and at least one layer of barrier material. In order to achieve desired barrier properties to weight ratios for the fabric structure, the spunbond filaments preferably have a denier in the range of about 0.7 to 1.2, and preferably have a denier less than or equal to about 1. The general nature of this construction means is generally described in the commonly owned U.S. application Ser. No. 09/972,299, filed Oct. 5, 2001.

A spunbond process involves supplying a molten polymer, which is then extruded under pressure through a large number of orifices in a plate known as a spinneret or die. The resulting continuous filaments are quenched and drawn by any of a number of methods, such as slot draw systems, attenuator guns, or Godet rolls. The continuous filaments are collected as a loose web upon a moving foraminous surface, such as a wire mesh conveyor belt. When more than one spinneret is used in line for the purpose of forming a multi-layered fabric, the subsequent webs is collected upon the uppermost surface of the previously formed web. The web is then at least temporarily consolidated, usually by means involving heat and pressure, such as by thermal point bonding. Using this bonding means, the web or layers of webs are passed between two hot metal rolls, one of which has an embossed pattern to impart and achieve the desired degree of point bonding, usually on the order of 10 to 40 percent of the overall surface area being so bonded.

The thermoplastic polymers of the continuous filament spunbond layer or layers are chosen from the group consisting of polyolefins and polyesters, wherein the polyolefins are chosen from the group consisting of polypropylene, polyethylene, and combinations thereof. It is within the purview of the present invention that the continuous filament spunbond layer or layers may comprise either the same or different thermoplastic polymers. Further, the continuous filaments of the spunbond layer or layers may comprise homogeneous, bicomponent, and/or multi-component profiles and the blends thereof.

The barrier layer comprises a fibrous material selected from suitable media, such media include: meltblown, cellulosic pulp, microporous film or monolithic film, with microfiber media such as meltblown being preferred. Cellulosic pulp barrier layers are well-known for providing a useful barrier performance in medical applications and include such materials as wood pulp, in either a wetlaid tissue form or as an airlaid fibrous layer. Suitable microporous film barrier layer can include materials such as those reported in U.S. Pat. No. 5,910,225 herein incorporated by reference, in which pore-nucleating agents are used to form the micropores. Monolithic films as reported in U.S. Pat. No. 6,191,221, herein incorporated by reference, can also be utilized as a suitable barrier means.

A preferred mechanism for forming a barrier layer is through application of the meltblown process. The melt-blown process is a related means to the spunbond process for forming a layer of a nonwoven fabric, wherein, a molten polymer is extruded under pressure through orifices in a spinneret or die. High velocity air impinges upon and entrains the filaments as they exit the die. The energy of this step is such that the formed filaments are greatly reduced in diameter and are fractured so that microfibers of finite length are produced. This differs from the spunbond process whereby the continuity of the filaments is preserved. The process to form either a single layer or a multiple-layer fabric is continuous, that is, the process steps are uninterrupted from extrusion of the filaments to form the first and subsequent layers through consolidation of the layers to form a composite fabric.

To form fine denier spunbond layers from conventional spunbond equipment, several process parameters are modified. The fine-fiber spunbond material is made by decreasing the extrusion rate, while maintaining or increasing the rate of quench and draw of the filaments. A thermoplastic polymer can be selected to provide adequate melt strength so as to minimize fiber breaks during the fiber draw-down process. The actual extrusion and quench temperatures utilized and the other specific changes to the process will depend upon the polymer resin and the specific spunbond equipment. Specialized, performance-enhanced spunbond layers such as those high-speed spinning processes taught in U.S. Pat. No. 5,885,909, herein incorporated, can also be practiced.

The meltblown process, as well as the cross-sectional profile of the spunbond filament or meltblown microfiber are not a critical limitation to the practice of the present invention.

By providing a fine denier spunbond layer upon which the meltblown layer may deposited, several enhancements of the fabric are realized. For a given basis weight of the spunbond layer, a finer denier fabric will give a greater number of filaments and a smaller average pore size. The smaller average pore size will result in a more uniform deposition of the meltblown microfibers onto the spunbond layer. A more uniform meltblown layer will have fewer weak points in the web at which a failure in barrier performance can occur. The spunbond layer also serves to support the meltblown layer structurally in the composite material. A finer denier spunbond layer provides a smaller average pore size and a larger number of support points for the barrier layer, this results in shorter spans of unsupported meltblown microfibers. This mechanism embodies the well-known concept that reduction in the average span length results in enhanced structural integrity.

### EXAMPLES

Example 1 is a conventional SMS fabric comprising a spunbond layer basis weight being 17 gsm and a meltblown basis weight being 10 gsm. This construct was made in accordance with standard practices as applied to equipment supplied by Reifenhauser GmbH for the formation of fabric by thermal point bonding in a diamond pattern at a coverage area of 17%. A thermoplastic resin was provided in the form of Exxon 3155 polypropylene.

Example 2 is a conventional SMMS fabric comprising a spunbond layer basis weight being 15 gsm and a meltblown basis weight being 7.5 gsm. This construct was made in accordance with standard practices as applied to equipment supplied by Reifenhauser GmbH for the formation of fabric by thermal point bonding in a diamond pattern at a coverage area of 17%. A thermoplastic resin was provided in the form of Exxon 3155 polypropylene.

Example 3 is an SMS fabric made in accordance with the present invention, comprising a spunbond layer basis weight being 17 gsm and a meltblown basis weight being 8 gsm. The polypropylene resin used to form the spunbond layer was Achieve® 3854 available from Exxon Corporation. This construct was made in accordance with standard practices as applied to equipment supplied by Reifenhauser GmbH for the formation of fabric by thermal point bonding in an oval pattern at a coverage area of 18%.

Example 4 is an SMMS fabric made in accordance with the present invention, comprising a spunbond layer basis weight being 10 gsm and a meltblown basis weight being 5 gsm. The polypropylene resin used to form the spunbond layer was Achieve 3854 available from Exxon Corporation. This construct was made in accordance with standard practices as applied to equipment supplied by Reifenhauser GmbH for the formation of fabric by thermal point bonding in an oval pattern at a coverage area of 18%.

Example 5 is an SMMS fabric made in accordance with the present invention, comprising a spunbond layer basis weight being 17 gsm and a meltblown basis weight being 8 gsm. The polypropylene resin used to form the spunbond layer was Achieve 3854 available from Exxon Corporation. This construct was made in accordance with standard practices as applied to equipment supplied by Reifenhauser GmbH for the formation of fabric by thermal point bonding in an oval pattern at a coverage area of 18%.

Example 6 is an SMMS fabric made in accordance with the present invention, comprising a spunbond layer basis weight being 6 gsm and a meltblown basis weight being 2.5 gsm. The polypropylene resin used to form the spunbond layer was Achieve 3854 available from Exxon Corporation. This construct was made in accordance with standard practices as applied to equipment supplied by Reifenhauser GmbH for the formation of fabric by thermal point bonding in an oval pattern at a coverage area of 18%.

Example 7 is an SMMS fabric made in accordance with the present invention, comprising a spunbond layer basis weight being 7 gsm and a meltblown basis weight being 3 gsm. The polypropylene resin used to form the spunbond layer was Achieve 3854 available from Exxon Corporation. This construct was made in accordance with standard practices as applied to equipment supplied by Reifenhauser GmbH for the formation of fabric by thermal point bonding in an oval pattern at a coverage area of 18%.

For comparison purposes, examples of SMS fabrics from the U.S. patent literature are also included in Table 1. Comparative sample A is a polypropylene SMS fabric described in U.S. Pat. No. 5,464,688. Comparative sample B is a polypropylene SMS fabric described in U.S. Pat. No. 5,482,765.

Table 1 sets forth composite fabrics formed in accordance with the present invention compared to conventional SMS and SMMS fabrics. In Table 1, the regular denier SMS material (Example 1) is shown as having layers formed with various individual basis weights of 17 gsm/10 gsm/17 gsm. The denier of the spunbond layer was measured by common technique and was found to be 1.7 denier. The meltblown fiber diameters were measured to give an average of 2.0 microns. An SMMS material is also shown in Table 1 shown as having layers formed with various individual basis weights of 15 gsm/7.5 gsm/7.5 gsm/15 gsm. The spunbond layers have filaments of 2.3 denier and the average meltblown diameter is 2.8 microns. The conventional SMS and SMMS fabrics exhibit hydrostatic head values of 36.8 and 53 cm respectively. Normalization of the hydrostatic head values for the two constructions to the meltblown basis weight gives values of 3.7 and 3.5 cm/gsm, respectively.

Example 3 represents a polypropylene SMS fabric made in accordance with the invention, with individual layers of the following basis weights, 17 gsm/8 gsm/17 gsm. The denier of the spunbond layer was measured by common technique and was found to be 1.0 denier. The meltblown fiber diameters were measured to give an average of 2.1 microns. The hydrostatic head to basis weight ratio for the fabric of Example 3 is 6.1. The improvement of barrier property in the material made in accordance with this invention as measured by hydrostatic head represents a 65% increase per gram per square meter of the meltblown barrier layer.

Comparative sample of SMS barrier fabrics reported in the U.S. Patent literature are listed in Table 1. The total basis weight for these two fabrics is 47 and 54 gsm respectively, with each fabric having a meltblown basis weight of 17 gsm. The hydrostatic head to basis weight ratio for these products are 1.8 and 3.1 cm/gsm respectively. These values are significantly lower than the values found for Example 3.

Example 4 represents a polypropylene SMMS fabric made in accordance with the invention, with individual layers of the following basis weights, 10 gsm/5 gsm/5 gsm/10 gsm. The denier of the spunbond layer was measured by common technique and was found to be 1.1 denier. The meltblown fiber diameters were measured to give an average of 1.9 microns. The hydrostatic head to basis weight ratio for the fabric of Example 4 is 4.9 cm/gsm. The improvement of barrier property in the material made in accordance with this invention as measured by hydrostatic head represents a 40% increase per gram per square meter of the meltblown barrier layer.

Other representative fabrics are presented in Table 1. Examples 5-7 demonstrate the high ratio of hydrostatic head to meltblown basis weight, 7.4 and 0.8 cm/gsm respectively, in lightweight constructs as embodied in the present invention. Such lightweight constructs are particularly advantageous when used in the fabrication of end-use articles requiring significant barrier performance.

From the foregoing, numerous modifications and variations can be effected without departing from the true spirit and scope of the novel concept of the present invention. It is to be understood that no limitation with respect to the specific embodiments disclosed herein is intended or should be inferred. The disclosure is intended to cover, by the appended claims, all such modifications as fall within the scope of the claims.

TABLE 1

| | | Examples | | | | | | | Comparative Samples | |
|---|---|---|---|---|---|---|---|---|---|---|
| PROPERTY | UNIT | 1 | 2 | 3 | 4 | 5 | 6 | 7 | A | B |
| Layer basis weight | gsm | 17/10/17 | 15/7.5/7.5/15 | 17/8/17 | 10/5/5/10 | 17/8/8/17 | 6/2.5/2.5/6 | 7/2/2/7 | 15/17/15 | 18.7/17/18.7 |
| Fabric basis | gsm | 44 | 45 | 42 | 30 | 50 | 17 | 18 | 47 | 54 |
| weight | | | | | | | | | | |
| Melt blown basis | gsm | 10 | 15 | 8 | 10 | 16 | 5 | 4 | 17 | 17 |
| weight | | | | | | | | | | |
| MD Grabs | g/cm | 5960 | 4590 | 8102 | 4890 | 3776 | 448 | 324 | | |
| CD Grabs | g/cm | 4120 | 3253 | 6472 | 3473 | 2631 | 121 | 61 | | |
| MD Elongation | % | 62 | 55.5 | 50 | 50 | 39 | 19 | 20 | | |
| CD Elongation | % | 80 | 65.5 | 72 | 64 | 57 | 121 | 30 | | |
| Hydrostatic head | cm | 36.8 | 53 | 49 | 49 | 90 | 37 | 31 | 29.9 | 53 |
| HSH/Meltblown | cm/gs | 3.7 | 3.5 | 6.1 | 4.9 | 5.6 | 7.4 | 7.8 | 1.8 | 3.1 |
| Basis Weight | m | | | | | | | | | |

What is claimed is:

1. A protective outdoor fabric, comprising
a) a fine-denier spunbond layer comprising a plurality of continuous thermoplastic filaments having a denier of between 0.7 and 1.2 denier;
b) a barrier layer material deposited uniformly onto the fine denier spunbond layer and the layers consolidated to form a composite fabric; and
c) said composite fabric having a hydrostatic head to barrier layer basis weight ratio of about at least 4.9 cm/gsm.

2. A protective outdoor fabric as in claim 1, wherein:
said thermoplastic filaments are chosen from the group consisting of polyolefins, polyesters, polyamides and the blends thereof.

3. A protective outdoor fabric as in claim 2, wherein:
said polyolefins are chosen from the group consisting of polypropylene, polyethylene, and blends thereof.

4. A protective outdoor fabric as in claim 1, wherein: the continuous filaments may comprise bicomponent or multicomponent profiles and the blends thereof.

5. A protective outdoor fabric as in claim 1, wherein the barrier layer is selected from the group consisting of meltblown, cellulosic pulp, microporous film and monolithic film.

6. A protective outdoor fabric as in claim 5, wherein:
said melt-blown barrier layer having fiber diameters in the range of about 1 to 10 microns.

7. A protective outdoor fabric as in claim 6, wherein:
said melt-blown barrier layer comprises thermoplastic polymer.

8. A protective outdoor fabric as in claim 1, wherein:
said means of consolidation are chosen from the group consisting of pressure bonding, thermal calendering, and through-air bonding.

9. A protective outdoor fabric as in claim 1, wherein said fabric is used in the construction of a car cover.

10. A protective outdoor fabric as in claim 1, wherein said fabric is used in the construction of a tent.

11. A protective outdoor fabric, comprising
a) a first fine-denier spunbond layer comprising a plurality of continuous thermoplastic filaments having a denier of between 0.7 and 1.2 denier;
b) a barrier layer material deposited onto the first fine denier spunbond layer;
c) a second spunbond layer comprising a plurality of continuous thermoplastic filaments having a denier of between 0.7 and 1.2 denier deposited onto the barrier layer;
d) the first fine denier spunbond layer, the barrier layer, and the second spunbond layer being consolidated into a composite fabric structure; and
e) said composite fabric having a hydrostatic head to barrier layer basis weight ratio of about at least 4.9 cm/gsm.

12. A protective outdoor fabric as in claim 9, wherein the second spunbond layer is a fine-denier spunbond layer.

13. A protective outdoor fabric as in claim 9, wherein:
said thermoplastic filaments are chosen from the group consisting of polyolefins, polyesters, polyamides and blends thereof.

14. A protective outdoor fabric as in claim 9, wherein: said thermoplastic filaments of the first and second fine denier spunbond layer comprise different thermoplastic polymers.

15. A protective outdoor fabric as in claim 10, wherein:
said barrier layer is a melt-blown barrier layer having fiber diameters in the range of 1 to 10 microns.

16. A protective outdoor fabric, comprising:
a) a first fine-denier spunbond layer comprising a plurality of continuous thermoplastic filaments having a denier of between 0.7 and 1.2 denier;
b) a first barrier layer material deposited onto the first fine denier spunbond layer;
c) a second barrier layer deposited onto the first barrier layer;
d) a second spunbond layer comprising a plurality of continuous thermoplastic filaments having a denier of between 0.7 and 1.2 denier deposited onto the second barrier layer;
e) said layers being consolidated into a composite fabric structure; and
f) said composite fabric having a hydrostatic head to barrier layer basis weight ratio of about at least 4.9 cm/gsm.

17. A protective outdoor fabric as in claim 14, wherein the second spunbond layer is a fine-denier spunbond layer.

18. A protective outdoor fabric, as in claim 14, wherein:
said consolidation method includes thermal calendering said laminate fabric structure to exhibit a hydrostatic head rating of at least about 50 cm.
